(19) United States
(12) Patent Application Publication
(10) Pub. No.: US 2022/0099868 A1
(43) Pub. Date: Mar. 31, 2022

(54) SMART DEVICE CASE WITH BUILT-IN MIRROR WITH AN OPERATIVELY ASSOCIATED MULTI-TONAL LIGHT DIFFUSER

(71) Applicant: Antonio Cullari, Los Angeles, CA (US)

(72) Inventor: Antonio Cullari, Los Angeles, CA (US)

(21) Appl. No.: 17/445,754

(22) Filed: Aug. 24, 2021

Related U.S. Application Data
(60) Provisional application No. 63/083,284, filed on Sep. 25, 2020.

(51) Int. Cl. G02B 5/02

(52) U.S. Cl. CPC G02B 5/0278; H04M 1/026; G02B 5/0284

(57) ABSTRACT

A smart device case with built-in mirror with an adjustable multi-tonal light diffuser slider that selectively associates with the intrinsic light source of the smart device for enhancing images reflected off a reflective surface of the smart device case.

### CROSS-REFERENCE TO RELATED APPLICATION

This application claims the benefit of priority of U.S. provisional application No. 63/083,284, filed 25 Sep. 2020, the contents of which are herein incorporated by reference.

### BACKGROUND OF THE INVENTION

The present invention relates to smart device accessories and, more particularly, a smart device case with built-in mirror with an operatively associated multi-tonal light diffuser.

Viewing oneself in a mirror is a need that most people experience any given day. And the ubiquity of mobile phones offers a handy supporting surface for a mirror to meet such need. Though, however, with a thin profile and a smallish supporting surface available, frequently there would not be sufficient (soft) light for a high-quality reflection off a mirror coupled to a smart device or its case.

In optics, a diffuser is any material that diffuses or scatters light in some manner to transmit soft light, even during poor lighting situations, to improve the image captured (reflected) off a mirror through diffusing light at a certain amount and/or at a certain angle.

Currently mobile-based mirrors are of poor quality and do not provide a good reflection because they lack diffused light. Furthermore, current solutions have a lighting mechanism that requires an independent charge.

As can be seen, there is a need for a smart device case with built-in mirror with an adjustable multi-tonal light diffuser that selectively associates with the intrinsic light source of the smart device. The proper invention utilizes the light from the smart device's flashlight and/or flash and selectively diffuses that light for different light enhancement to a reflective surface also provided by the smart device case embodied by the present invention, resulting in a high-quality, diffused reflection on demand.

### SUMMARY OF THE INVENTION

In one aspect of the present invention, a device case includes: a reflective surface; and one or more diffusers selectively movable relative to the reflective surface.

In another aspect of the present invention, the device case further includes a slider housing operatively associated with the one or more diffusers for selective movement thereof; a slider coupled to the one or more diffusers, wherein the slider is moveable between a non-diffused position and one or more diffused positions; a track provided by the slider housing; and a grooved rider along a proximal end of the slider, wherein the grooved riders rides along the track when moving between the non-diffused position and the one or more diffused positions, wherein the one or more diffusers comprising a first diffuser and a second diffuser, and where the one or more diffused positions comprises a first diffused position and a second diffused position, wherein the first diffuser is a translucent diffuser and the second diffuser is an opaque diffuser; a frame interconnected to the slider housing and the reflective surface; and including a wrap dimensioned to engage a periphery of a device, wherein the wrap engages the frame so that the slider housing is adjacent an intrinsic light source of the device.

In yet another aspect of the present invention, a system for coupling a mirror to a device, the system providing: a device; and a device case comprising: a reflective surface; and one or more diffusers selectively movable between a non-diffused position and one or more diffused positions, wherein each diffused position comprises one of the one or more diffusers is at least partially coextensive with an intrinsic light source of the device.

In yet another aspect of the present invention, a method of coupling a mirror to a device, the method including coupling the device with a smart device case, the smart device case providing: a reflective surface; and one or more diffusers selectively movable between a non-diffused position and one or more diffused positions, wherein each diffused position comprises one of the one or more diffusers is at least partially coextensive with an intrinsic light source of the device.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention.

FIG. 2 is an exploded perspective view of an exemplary embodiment of the present invention.

FIG. 3 is a front elevation view of an exemplary embodiment of the present invention, with the slider not in use.

FIG. 4 is a front elevation view of an exemplary embodiment of the present invention, illustrating the slider in use with an opaque diffuser.

FIG. 5 is a front elevation view of an exemplary embodiment of the present invention, illustrating the slider in use with a translucent diffuser.

FIG. 6 is a section view of an exemplary embodiment of the present invention, taken along line 6-6 in FIG. 1.

FIG. 7 is a section view of an exemplary embodiment of the present invention, taken along line 7-7 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a smart device case with built-in mirror with an adjustable multi-tonal light diffuser slider that selectively associates with the intrinsic light source of the smart device for enhancing images reflected off a reflective surface of the smart device case.

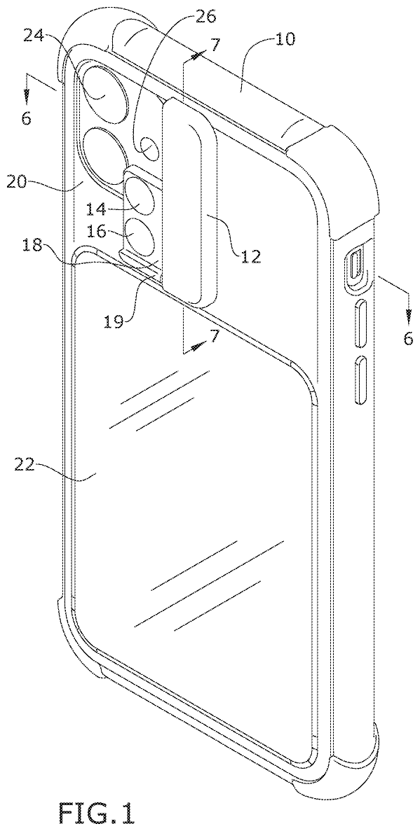

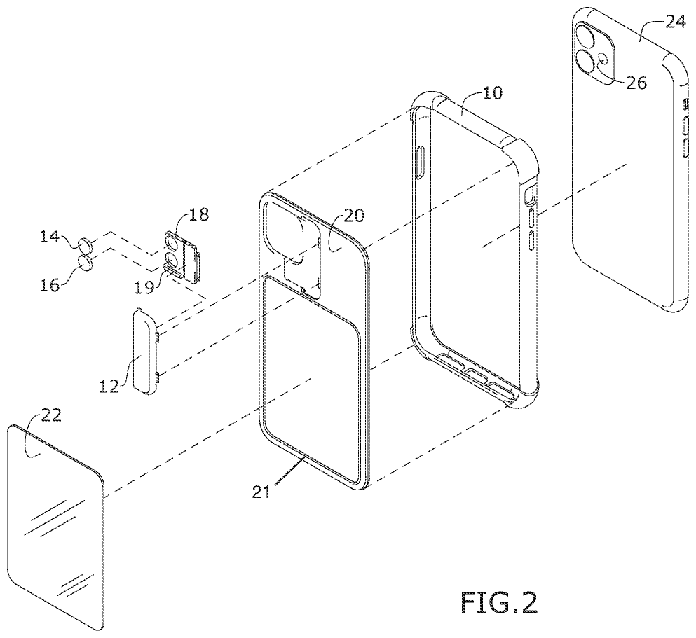

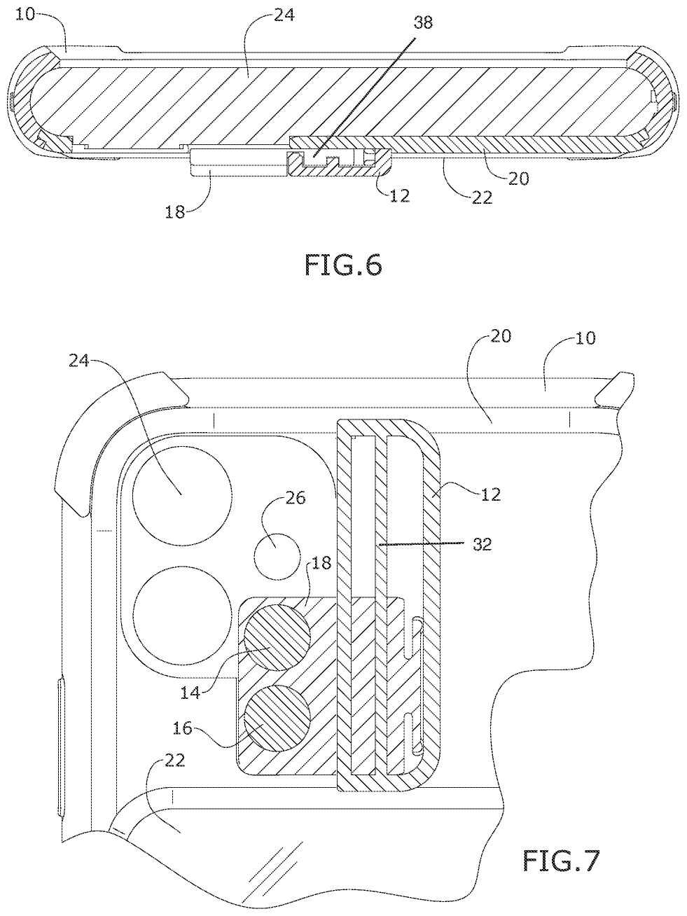

Referring now to FIGS. 1 through 7, the present invention may include a transparent plasticized material that offers malleability, flexibility and softness, such as a polyurethane plastic, formed into at least a peripheral portion 10 of a case for a smart device 24. Accordingly, the case 10 may provide the molded button and openings for speakers, user interface, plug, and switch, and the like. The peripheral portion 10 may be generally hollow geometric shape to accommodate the perimeter of the smart device 24. The inner periphery or edge of the peripheral portion 10 may engage a frame 20 adapted to cover a lighting side of the smart device—i.e., the side providing its intrinsic light source 26. The thin planar frame 20 may provide a reflective surface 22, such as a scratch-resistant acrylic mirror or the like. In certain embodiments, the reflective surface 22 is integrated with the frame 20, while in other embodiments, the frame 21 may provide an opening 21 dimensioned and adapted to secure the reflective surface 22 along its perimeter.

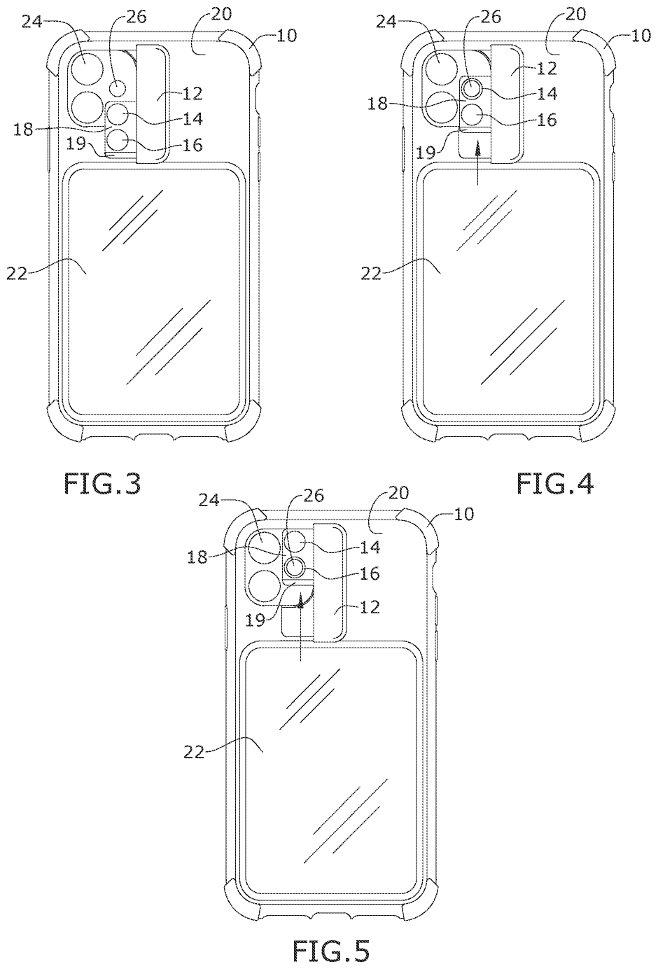

The frame 20 also provides for a slider housing 12 to be disposed adjacent the light source 26. The slider housing 12 operatively associates with a slider 18 in such a way as to be moveable between a non-diffused position (see FIG. 3), translucently diffused position (see FIG. 4), and an opaquely diffused position (see FIG. 5). In the non-diffused position, the slider 18 does not obscure the lighting source 26. The slider 18 provides a translucent diffuser 14 and an opaque diffuser 16 adjacent the translucent diffuser 14, wherein the translucently diffused position the translucent diffuser 14 overlaps the light source 26, and wherein the opaquely diffused position the opaque diffuser 16 overlaps the light source 26. The slider 18 may provide a slider lip handle 19, wherein the slider lip handle 19 provides a fingerhold for the user to engage the slider 18 for moving it between the different diffuser-related positions.

The slider 18 may be polycarbonate or other sufficiently durable material of sufficient capacity for holding the diffusers 14 and 16. The slider housing 12 may provide an interior track 32 that operatively associates with a grooved rider 38 coupled to a proximal end of the slider 18, thereby the slider 18 rides or slidably moves along the track 32. It is understood that other methodologies of having one object slide relative to another engaged object is within the ambit of this disclosure.

A method of using the present invention may include the following. A user may encase their smart device 24 into the case so that the light source 26 of the smart device is disposed adjacent the slider housing 12. Then the user may, by sliding the slider 18 up or down (or in other embodiments, left and right) may selectively move the slider 18 between the non-diffused position, the translucently diffused position, and/or the opaquely diffused position when they are using the reflective surface to provide a sufficient quality of light for a desired reflection.

It should be understood that the diffusers may be lighter or darker than pure translucent or opacity, such as grey, semi-translucent, white, and the like. In certain embodiments, the slider 18 operation mechanism holding the diffusers may slide horizontally as well as vertically to accommodate different cell phone models and light configurations.

It should be understood, of course, that the foregoing relates to exemplary embodiments of the invention and that modifications may be made without departing from the spirit and scope of the invention as set forth in the following claims.

What is claimed is:

1. A device case, comprising:
a reflective surface; and
one or more diffusers selectively movable relative to the reflective surface.

2. The device case of claim 1, further comprising:
a slider housing operatively associated with the one or more diffusers for selective movement thereof.

3. The device case of claim 2, further comprising:
a slider coupled to the one or more diffusers, wherein the slider is moveable between a non-diffused position and one or more diffused positions.

4. The device case of claim 3, further comprising:
a track provided by the slider housing; and
a grooved rider along a proximal end of the slider, wherein the grooved riders rides along the track when moving between the non-diffused position and the one or more diffused positions.

5. The device case of claim 4, further comprising:
wherein the one or more diffusers comprising a first diffuser and a second diffuser, and where the one or more diffused positions comprises a first diffused position and a second diffused position.

6. The device case of claim 5, further comprising:
wherein the first diffuser is a translucent diffuser and the second diffuser is an opaque diffuser.

7. The device case of claim 6, further comprising:
a frame interconnected to the slider housing and the reflective surface.

8. The device case of claim 7, further comprising:
a wrap dimensioned to engage a periphery of a device, wherein the wrap engages the frame so that the slider housing is adjacent an intrinsic light source of the device.

9. A system for coupling a mirror to a device, the system providing:
a device; and
a device case comprising:
a reflective surface; and
one or more diffusers selectively movable between a non-diffused position and one or more diffused positions, wherein each diffused position comprises one of the one or more diffusers is at least partially coextensive with an intrinsic light source of the device.

10. A method of coupling a mirror to a device, the method comprising:
coupling the device with a smart device case, the smart device case comprising:
a reflective surface; and
one or more diffusers selectively movable between a non-diffused position and one or more diffused positions, wherein each diffused position comprises one of the one or more diffusers is at least partially coextensive with an intrinsic light source of the device.
